(19) United States
(12) Patent Application Publication
(10) Pub. No.: US 2023/0227300 A1
(43) Pub. Date: Jul. 20, 2023

(54) MACHINE STABILITY DETECTION AND INDICATION FOR MOBILE LIFTING EQUIPMENT

(71) Applicant: Delaware Capital Formation, Inc., Wilmington, DE (US)

(72) Inventors: DAVID MICHAEL BEREZOWSKI, Broken Arrow, OK (US); KENNETH W. BLAKE, Bristow, OK (US); ANDREW HARMON, Tulsa, OK (US)

(21) Appl. No.: 18/097,950

(22) Filed: Jan. 17, 2023

Related U.S. Application Data
(60) Provisional application No. 63/300,249, filed on Jan. 17, 2022.

(51) Int. Cl. B66F 17/00; B66F 9/065; B66F 9/075

(52) U.S. Cl. CPC B66F 17/003; B66F 9/0655; B66F 9/0755

(57) ABSTRACT

A machine stability detection and indication for a load moving machine. The machine has a chassis, a boom mount carried by said chassis, a boom assembly pivotally affixed to said boom mount, and a load carrying structure affixed to an end of said boom mount. The machine may be configured in a desired load handling geometry by manipulating components including a boom assembly, a pivot arm connected to said boom assembly, and forks. A control system for facilitating a selected configuration of said load handling geometry. Position sensors generate position data of the components. Pressure cylinders move the components and pressure sensors operatively located on one or more said pressure cylinders generate pressure data. A computer processes the position data and the pressure data for determining a load moment and for calculating a weight of a load being lifted by utilizing said pressure data and said position data.

### CROSS-REFERENCE TO RELATED CASES

This application claims the benefit of U.S. provisional patent application Ser. No. 63/300,249, filed on Jan. 17, 2022, and incorporates such provisional application by reference into this disclosure as if fully set out at this point.

### FIELD OF THE INVENTION

This disclosure relates to mobile lifting equipment in general and, more specifically, to a system and method for determining longitudinal and latitudinal load moments for detecting machine stability.

### BACKGROUND OF THE INVENTION

A telescopic handler, also called a lull, telehandler, teleporter, reach forklift, or zoom boom, is a machine widely used in agriculture and industry. A telescopic handler or telehandler is somewhat like a forklift but has a boom or telescopic cylinder, which makes a telehandler have more characteristics of a crane than of a forklift. A telehandler typically utilizes a single telescopic boom that can extend forwards and upwards from the vehicle. The boom can be fitted with different attachments, such as a bucket, pallet forks, a winch or a block for redirecting cable similar to a crane. Some telehandlers possess capacity and reach sufficient carry out many of the tasks traditionally undertaken by mobile and tower cranes.

As with all lifting equipment, safe operation of telehandlers depends on a number of factors including telehandler capacity, the load carried by the telehandler, the height or distance that the load is carried or lifted from the telehandler, which relates to terrain features, boom angle, and forces imparted upon the telehandler due to motion of the telehandler.

A good description of telehandler features and safety considerations is available from the Construction Plant-hire Association of London, UK the document, “Safe Use of Telehandlers in Construction” available at:

https://www highwayssatetyhub.com/uploads/5/1/2/9/51294565/2d_-_guidance_on_safe_use_of_telehandlers.pdf

### SUMMARY OF THE INVENTION

Embodiments of the present disclosure are illustrated with respect to a telehandler, also known as a reach forklift or a zoom boom. However, those of skill in the art will appreciate that any load moving machine, or any machine with a variable center of gravity, may benefit from systems and methods of the present disclosure.

As shown in FIG. 5A, a telehandler or other load moving machine, with the load carried low to the ground surface may be placed at a substantial angle (laterally or longitudinally) before there is danger of an upset as the center of gravity remains within the boundary of the wheels or other structure contacting ground. As shown in FIG. 5B, in the example of a telehandler, lifting of the boom, forks, and/or load raises the center of gravity. This reduces the tilt that can be tolerated as the elevated center of gravity can more easily cross outside the boundary of any supporting structing in contact with the ground.

Devices that move loads can also experience dynamic instabilities. FIG. 6 illustrates an overturning moment that is experienced, even on level ground, as a turn is made while the machine is moving. The higher the center of gravity, the greater the overturning moment in a given turn is experienced by the machine; and the slower a turn must necessarily be to avoid an overturn.

Some machines, such as some telehandlers, some forklifts, and others, may steer from the front, rear or both. Wheel angle, front or rear, can affect overturning forces even if the vehicle is sitting still.

According to various embodiments of the present disclosure a system may comprise a plurality of sensors that measure boom length, boom angle, fork and/or attachment angle, chassis angle, cylinder pressures, topography features, machine characteristics, and/or other parameters. Geometric principles can be applied to determine the load moment and actual weight of item being lifted irrespective of the boom length, boom angle, or chassis angle. Terrain sensors located near the driving components (i.e., tires or tracks) can indicate impending changes to the topography which could affect stability.

According to various embodiments, a system may comprise, without limitation, boom length sensors, boom angle sensor, hydraulic pressure sensors, chassis angle sensors, an/or terrain sensor. In some cases, multiples of some or all sensors may be included.

Information or data from the various sensors may be fed to a computer for performing various calculations to arrive at a load moment, weight, or other computer parameter. It should be understood that the system may include necessary amplification and signal conditioning circuitry. Information may pass from a sensor to the computer via wire or wirelessly according to various protocols as are known in the art. The computer itself may be based on a general-purpose computer programmed appropriately for the tasks. It may also be based fully, or in part, on application specific integrated circuits, field programmable gate arrays, or other devices as are known in the art to be made capable of carrying out the necessary calculations.

In some embodiments, a display, a visual alarm, an audible alarm, or even tactile feedback for the user may be controlled by the computer. For example, a visual alarm, an audible alarm, and or a display message may be provided if an allowable load is exceeded or if there is current or impending risk of overturn. The computer may record, log, or store in non-volatile memory the gathered data and/or calculations for future reference or analysis.

A system according to the present disclosure may display information to inform the operator of a change to the load handling geometry (e.g., boom length, boom angle, chassis angle, topography, load, and capacity) which may aid in operational awareness of the working limits of the machine. The system may also display and/or otherwise provide outputs that can warn the operator of a change to the load handling geometry which would increase the load moment beyond longitudinal and/or lateral pre-determined limit(s). In some embodiments, the system is arranged to provide outputs that could prevent the operator changing the load handling geometry in direction(s) which would increase the moment load beyond the pre-determined allowable limit(s). Integration with machine controls and control systems may prevent machine travel, limit, or stop travel speed, or allow boom to only move in a direction that will reduce moment load.

Systems of the present disclosure may also be compatible with integrated hydraulic self-leveling fork/attachment systems. By measuring the forces induced by the system master cylinders attached to the main boom and compensating appropriately, the induced longitudinal or lateral moment of the machine can be determined.

It should be appreciated that, among other benefits, systems and methods of the present disclosure are scalable and adaptable to most, if not all, commercially available mobile lifting equipment

In some embodiments, in addition to, or instead of alarms, controls, and/or outputs directly from the system, the data (measurements, calculations, warning/alarm conditions, or others) may be passed to an OEM control computer.

It should be clearly understood that current load moment detection and indication systems are focused on longitudinal operations. In other words, to make certain that a load moment does not exceed a given value in the plane of the operating boom. The present system, among other benefits, allows measurement and determination of lateral moments, thus providing additional reduction in risk of overturns.

As shown in FIG. 7, load charts may be developed that indicate safe lifting weights for a telehandler, specifically (other load charts are developed for other machines, as is known in the art). Such charts are based on boom angle, and extension (and possibly other parameters). Heavier weights may be lifted and handled if the boom is less extended, for example. For safe operation, it is important to know not only geometric angles, but weight of the load as well.

Sensors may be located to measure hydraulic pressure in the bore end of the boom lift cylinder or cylinders, hydraulic pressure sensors in the rod end of the boom lift cylinder or cylinders, hydraulic pressure sensors in the bore end of the fork leveling master cylinder or cylinders, hydraulic pressure sensors in the rod end of the fork leveling master cylinder or cylinders. A single axis angle sensor may be mounted to the boom, a two-axis angle sensor mounted to the chassis, and a length sensor mounted to the boom.

As shown in the data of Appendix A, a system was validated with a finite element analysis (FEA) and shown to accurately describe the radius from the boom mount at various sensor identified locations, such as main, forks, or aux, as labelled. The FEA data was based on running of the system (labelled MG6) via a simulator vs FEA/CAD data to determine the accuracy.

Appendix A also compares the system against a physical test result to determine weight of the load with a high degree of accuracy. It was found that the calculated weight was generally accurate to greater than 99% but in no case less than 94%. With the ability to know both the weight of the load, and the geometry of the lifting machine, i.e., in this case, a telehandler, load moments and other data may be obtained or computed automatically as the machine is being used.

### BRIEF DESCRIPTION OF THE DRAWINGS

FIG. 1 is an elevation view of a load moving machine shown in a low, retracted load handling geometry with the forks in a low position;

FIG. 2 is an elevation view of the load moving machine of FIG. 1 shown in a low, retracted load handling geometry with the forks in a raised position;

FIG. 3 is an elevation view of the load moving machine of FIG. 1 shown in a medium extended load handling geometry;

FIG. 4 is an elevation view of the load moving machine of FIG. 1 shown in a fully extended load handling geometry;

FIG. 5A is a load moving machine having a load handling geometry wherein the load is carried low to the ground while on an incline;

FIG. 5B is the load moving machine having a load handling geometry wherein the load is carried higher from the ground while on an incline;

FIG. 6 is an illustration of an overturning moment on a load moving machine induced by a turn with the load lifted;

FIG. 7 is a telehandler load chart;

FIG. 8 is a schematic of a control system;

FIG. 9 is a schematic of a computer system with sensor inputs and feedback outputs.

### DETAILED DESCRIPTION OF THE PREFERRED EMBODIMENTS

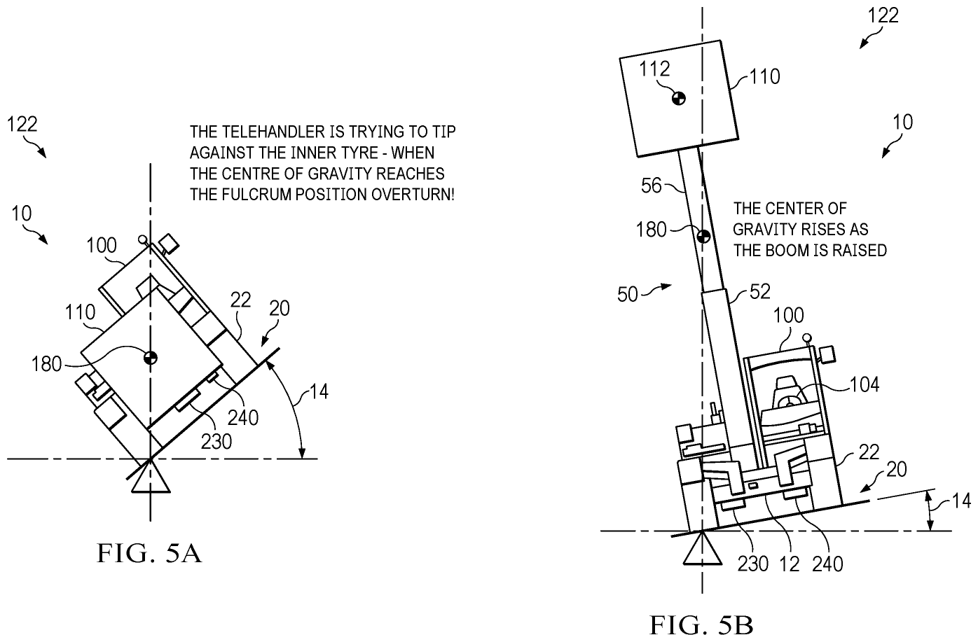

Referring now to the Figures, shown is a load moving machine or, more particularly, an exemplary telehandler 10. Telehandler 10 includes chassis 12. Chassis 12 defines chassis angle 14 with respect to horizontal (see, e.g., FIGS. 5A, 5B). Telehandler 10 includes supports 20 mounted to chassis 12 for supporting chassis 12. Example supports 20 include wheels 22 or tracks (not shown). Telehandler 10 may include an outrigger assembly, which is typically affixed to chassis 12. Telehandler 10 further includes boom mount 40 that is affixed to chassis 12.

Boom assembly 50 is pivotally affixed to boom mount 40. Boom assembly 50 includes a boom 52. In some embodiments, boom 52 receives first telescoping arm 54 and second telescoping arm 56. Boom assembly 50 defines boom end 58. Boom end 58 defines boom mount 60. In one embodiment, boom end 58 defines a block for redirecting a cable (not shown).

Pivoting arm 70 is pivotally affixed to boom mount 60 of boom assembly 50. Pivoting arm 70 defines arm end 72.

Fork mount 80 is affixed to arm end 72 of pivoting arm 70. Fork mount 80 facilitates raising and lowering. Forks 90 are mounted to fork mount 80. Forks 90 are capable of being raised and lowered via fork mount 80 for establishing a fork position.

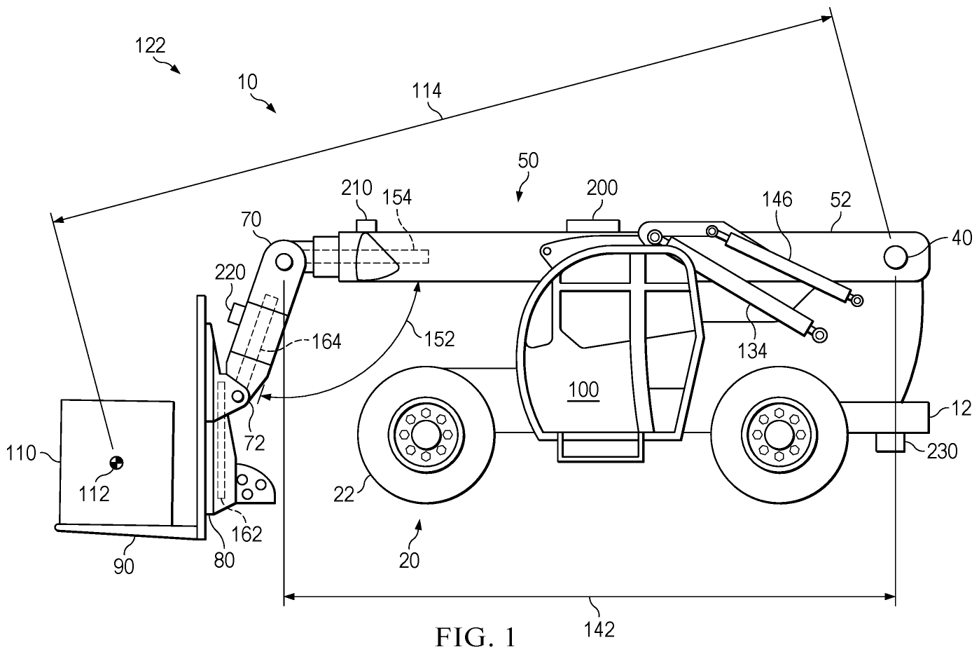

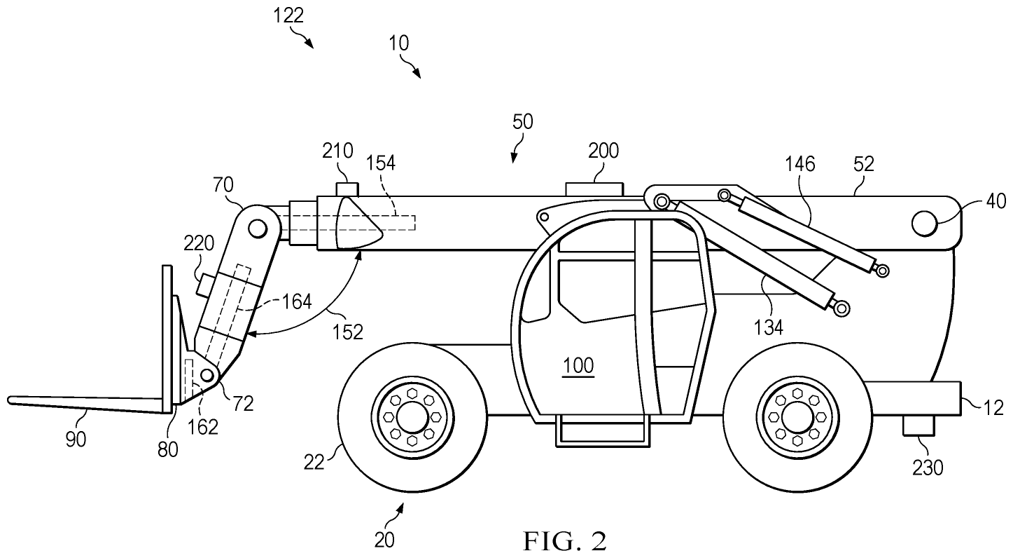

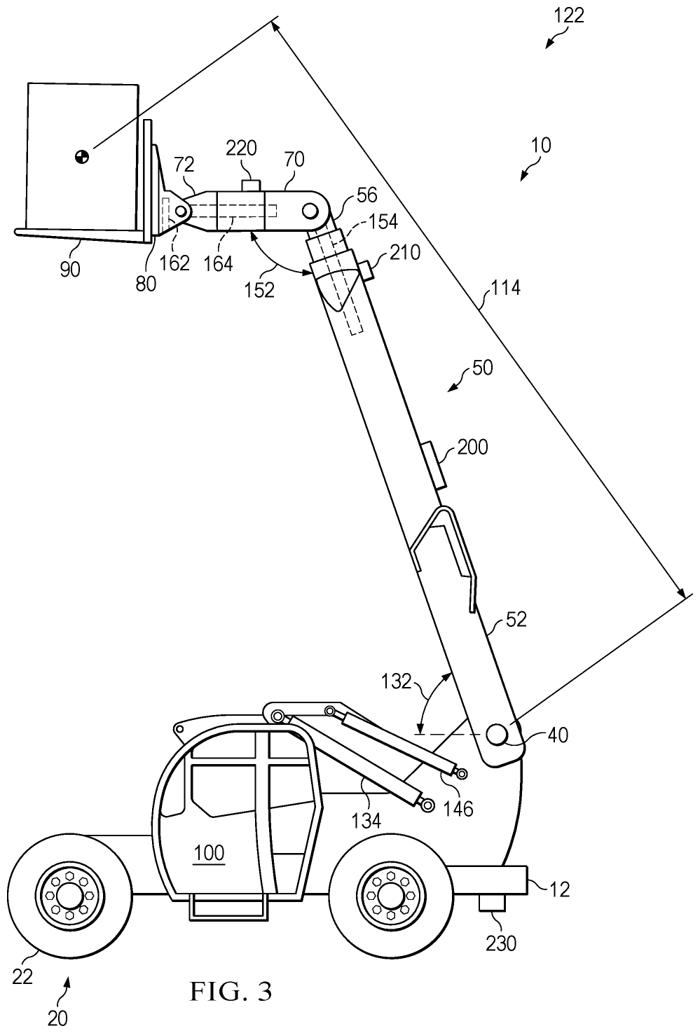

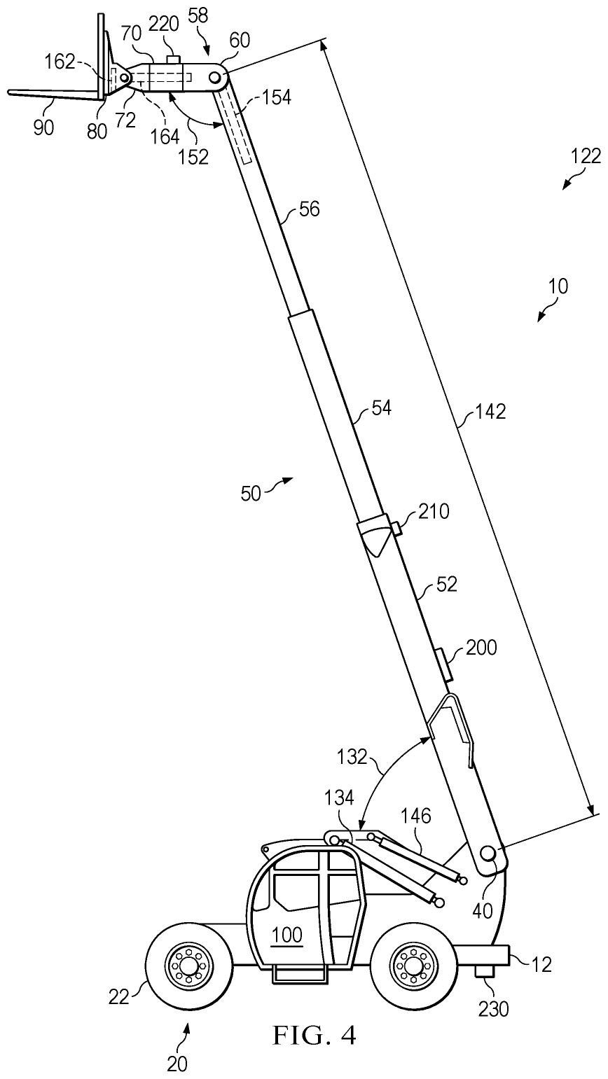

Operator compartment 100 is supported by chassis 12 for housing an operator 102 and machine controls 104. A load 110 is located on forks 90. Load 110 has a center of load mass 112. Center of load mass 112 defines a load radius 114 from center of load mass 112 (FIGS. 1, 3 and 5B) to boom mount 40.

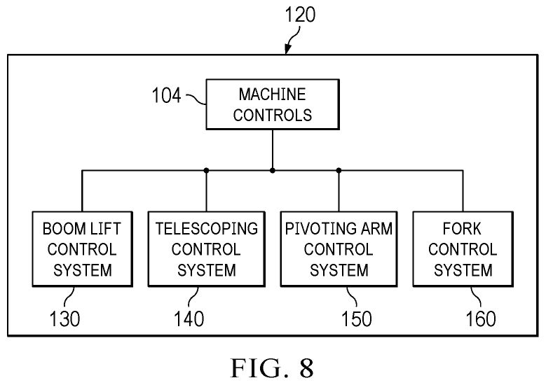

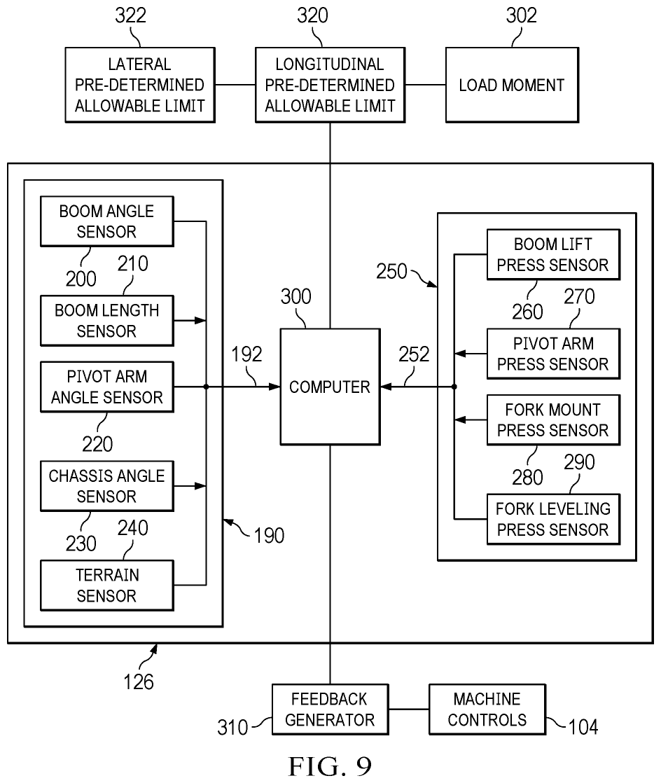

A control system 120 (FIGS. 8 and 9) facilitates a selected load handling geometry 122 of telehandler 10. As shown in FIG. 8, control system 120 includes at least one of machine controls 104, boom control system 130, telescoping control system 140, pivoting arm control system 150, and fork mount control system 160.

Boom lifting control system 130 is for angularly rotating boom 52 and, therefore, for angularly rotating boom assembly 50 relative to chassis 12 for establishing boom angle 132. Boom lifting control system 130 includes boom lift cylinder 134 having a rod end 136 and a bore end 138.

Telescoping control system 140 is for selectively extending or retracting first telescoping arm 54 of boom assembly 50 for establishing length 142 and for determining a load radius 114. Telescoping control system 140 is also for selectively extending or retracting second telescoping arm 56 of boom assembly 50 for establishing boom length 142 and for determining load radius 114. Telescoping control system 140 includes boom extending cylinder 146 having a rod end 148 and a bore end 149.

Pivoting arm control system 150 is provided for selectively rotating pivoting arm 70 about boom end 58 of boom assembly 50 for establishing a pivot arm angle 152 with respect to boom assembly 50. Pivoting arm control system 150 includes pivot arm cylinder 154 with rod end 156 and bore end 158.

Fork control system 160 is provided for selectively levelling forks and for raising or lowering forks 90 on fork mount 80. Fork mount control system 160 includes fork mount cylinder 162 having rod end and bore end and a fork levelling cylinder 164 having a rod end and bore end.

Load handling geometry 122 may be manipulated by operator 102 with machine controls 104 of control system 120 for achieving desired configurations of one or more of boom angle 132, boom length 142, load radius 114, pivot arm angle 152, and chassis angle 14, topography 170, load 110, and capacity 172 of telehandler 10.

Telehandler 10 and load 110 together define center of gravity 180. Center of gravity 180 has a location that is a function of load handling geometry 122 of telehandler 10.

Position sensors 190 (FIG. 9) include one or more of boom angle sensor 200, boom length sensor 210, pivoting arm angle sensor 220, chassis angle sensor 230, and terrain sensor 240. Position sensors 190 generate position data 192.

In one embodiment, boom angle sensor 200 is a single axis sensor mounted to boom 52.

In one embodiment, boom length sensor 210 is a length sensor mounted to boom 52.

In one embodiment, pivoting arm angle sensor 220 is a single axis sensor mounted to pivoting arm 70.

In one embodiment, chassis angle sensor 230 is a two axis angle center mounted to chassis 12. Chassis angle sensor 230 is preferably configured to determine whether chassis 12 is level, at an angle oriented downhill, at an angle oriented uphill, or tilted at an angle to a right side or tilted at an angle to a left side.

In one embodiment, terrain sensor 240 is located near supports 20, i.e., near wheels 22 or tracks. Terrain sensor 240 is for indicating impending changes to topography that could affect stability of telehandler 10.

Pressure sensors 250 (FIG. 9) include one or more or boom lift pressure sensor 260, pivot arm pressure sensor 270, and fork pressure sensor 280. Pressure sensors 250 generate pressure data 252.

In one embodiment, boom lift pressure sensor 260 is located in a rod end of boom lift cylinder 134. In one embodiment, boom lift pressure sensor 260 is located in a bore end of boom lift cylinder 134.

In one embodiment, pivot arm pressure sensor 270 is located in a rod end of pivot arm cylinder 154. In one embodiment, pivot arm pressure sensor 270 is located in a bore end of pivot arm cylinder 154.

In one embodiment fork mount pressure sensor 280 is located in a rod end of fork mount cylinder 162. In one embodiment fork mount pressure sensor 280 is located in a bore end of fork mount cylinder 162.

In one embodiment fork levelling pressure sensor 290 is located in a rod end of fork levelling cylinder 164. In one embodiment fork levelling pressure sensor 290 is located in a bore end of fork levelling cylinder 164.

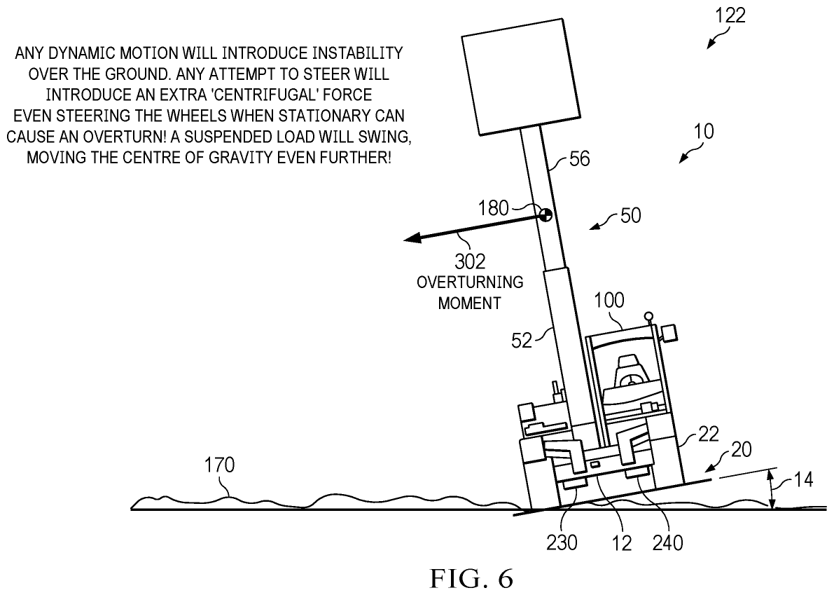

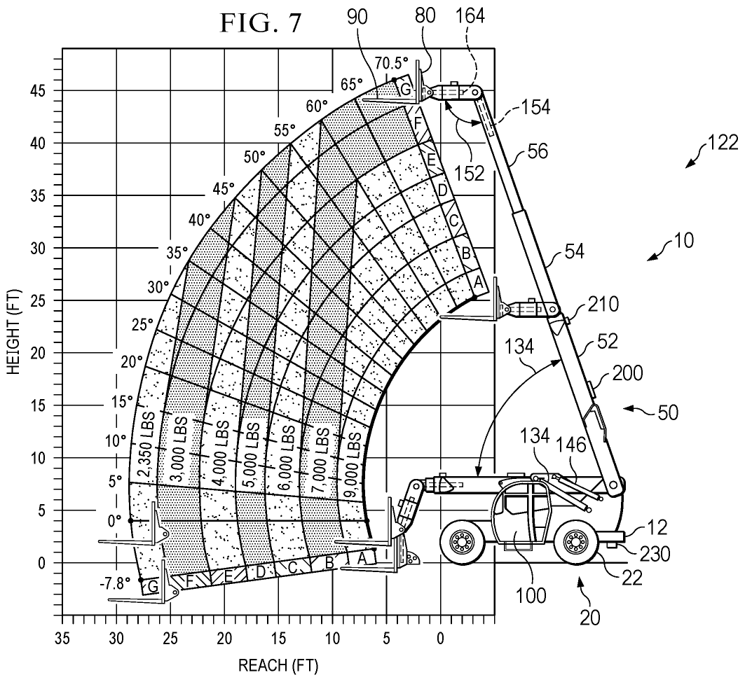

Computer 300 (FIG. 9) is provided for processing position data 192 from position sensors 190 and for processing pressure data 252 from pressure sensors 250. Computer 300 determines load moment 302 (FIG. 6) by applying geometric principles known in the art. Computer 300 additionally calculates a weight of load 110 being lifted by utilizing pressure data 252 and position data 192. Feedback generator 310 is controlled by computer 300. Feedback generator 310 includes at least one of a display system 312, a visual alarm 314, an audible alarm 316, or a tactile feedback mechanism 318.

In one embodiment, feedback generator 310 (FIG. 9) displays information on display system 312 for informing operator 102 of a change in load handling geometry 122 for aiding operator 102 when telehandler 10 is approaching working limits or for informing operator 102 of changes to load handling geometry 122 that would increase load moment 302 beyond a longitudinal predetermined allowable limit 320 or beyond a lateral predetermined allowable limit 322.

In one embodiment, feedback generator 310 provides outputs that prevent operator 102 from changing load handling geometry 122 into configurations that would increase load moment 302 beyond longitudinal predetermined allowable limit 320 and/or beyond a lateral predetermined allowable limit 322.

In one embodiment, feedback generator 310 is integrated with machine controls 104 and control system 120 to prevent travel of telehandler 10, to limit or stop travel speed of telehandler 10, or to allow boom 52 to only move in a direction that will reduce load moment 302.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Further, different aspects and embodiments of the invention may be used separately or together.

Additionally, further particular and preferred aspects of the present invention are set out in the accompanying independent and dependent claims. Features of the dependent claims may be combined with the features of the independent claims as appropriate, and in combinations other than those explicitly set out in the claims.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A load moving machine comprising:
a chassis supported by supports;
a boom mount carried by said chassis;
a boom assembly pivotally affixed to said boom mount, said boom assembly having an end, wherein a position of said boom assembly comprises at least a part of a load handling geometry of the load moving machine;
a control system for manipulating said boom assembly to facilitate a desired configuration of said load handling geometry of the load moving machine;
a position sensor operatively located on said boom assembly for generating position data of said boom assembly;
a pressure cylinder operatively connected to said boom assembly;
a pressure sensor for measuring pressure in said pressure cylinder, said pressure sensor for generating pressure data;
a computer for processing said position data from said position sensor and for processing pressure data from said pressure sensor, said computer for determining a load moment and for calculating a weight of a load being lifted by utilizing said pressure data and said position data.

2. The load moving machine according to claim 1 further comprising:
a pivot arm connected to said boom assembly;
wherein said control system is for manipulating said pivot arm to facilitate a desired configuration of said load handling geometry of the load moving machine;
a position sensor operatively located on said pivot arm for generating position data of said pivot arm;
a pressure cylinder operatively connected to said pivot arm, wherein said pressure cylinder is a pivot arm cylinder;
a pressure sensor for measuring pressure inside said pivot arm cylinder for generating pressure data.

3. The load moving machine according to claim 1 further comprising:
forks proximate said end of said boom assembly;
wherein said control system is for manipulating said forks to facilitate a desired configuration of said load handling geometry of the load moving machine;
a position sensor operatively located on said forks or on a fork mount of the load moving machine for generating position data of said forks;
a pressure cylinder operatively connected to said forks or to said fork mount, wherein said pressure cylinder is a fork leveling cylinder or a fork mount cylinder;
a pressure sensor for measuring pressure inside said fork leveling cylinder or said fork mount cylinder for generating pressure data.

4. The load moving machine according to claim 1 wherein:
said control system comprising at least one of machine controls, a boom lifting control system, a telescoping control system, a pivoting arm control system, and a fork mount control system.

5. The load moving machine according to claim 1 wherein:
said configuration of said load handling geometry comprises one of one or more of a boom angle, a boom length, a load radius, a pivot arm angle, a fork position, and a fork angle.

6. The load moving machine according to claim 1 further comprising:
an operator compartment supported by said chassis for housing an operator and machine controls.

7. The load moving machine according to claim 1 wherein:
said control system comprises a boom lifting control system;
said boom lifting control system is for angularly rotating said boom assembly, relative to said chassis for establishing a boom angle, said boom lifting control system comprising said pressure cylinder;
wherein said pressure cylinder is a boom lift cylinder.

8. The load moving machine according to claim 1 wherein:
said control system comprises a telescoping control system;
said telescoping control system is for selectively extending or retracting at least a first telescoping arm of said boom assembly for establishing a boom length and for establishing a load radius;
said telescoping control system comprising a boom extending cylinder.

9. The load moving machine according to claim 1 further comprising:
a pivoting arm pivotally affixed to said end of said boom assembly; and wherein:
said control system comprises a pivoting arm control system;
said pivoting arm control system for selectively rotating said pivoting arm about said end of said boom assembly for establishing a pivot arm angle, said pivoting arm control system comprising a pivot arm cylinder.

10. The load moving machine according to claim 1 further comprising:
a fork mount affixed to said boom assembly or to a pivoting arm;
forks affixed to said fork mount; and wherein
said control system comprises a fork mount control system;
said fork mount control system for selectively raising or lowering said forks on said fork mount, said fork mount control system comprising a fork mount cylinder.

11. The load moving machine according to claim 1 wherein said position sensor comprises:
a boom angle sensor mounted to said boom assembly.

12. The load moving machine according to claim 1 further comprising:
a pivoting arm pivotally affixed to said end of said boom assembly;
a pivoting arm angle sensor in communication with said pivoting arm.

13. The load moving machine according to claim 1 further comprising:
a chassis angle sensor mounted to said chassis, wherein said chassis angle sensor is configured to determine an orientation of said chassis with respect to horizontal.

14. The load moving machine according to claim 1 further comprising:
a terrain sensor located adjacent said supports for indicating impending changes to topography that could affect stability of the load moving machine.

15. The load moving machine according to claim 1 wherein:
said pressure cylinder is a boom lift cylinder; and
said pressure sensor is a boom lift pressure sensor in communication with a boom lift cylinder.

16. The load moving machine according to claim 1 further comprising:
a pivot arm pivotally connected to said end of said boom assembly;
a pivot arm cylinder operatively connected to said pivot arm;
a pivot arm pressure sensor in communication with said pivot arm cylinder.

17. The load moving machine according to claim 1 further comprising:
a fork mount affixed to said end of said boom assembly or to a pivoting arm;
a fork mount cylinder operatively connected to said fork mount;
a fork mount pressure sensor in communication with said fork mount cylinder.

18. The load moving machine according to claim 1 further comprising:
forks carried by a fork mount affixed to said end of said boom assembly or to a pivoting arm;
a fork leveling cylinder operatively connected to said forks;
a fork levelling pressure sensor in communication with said fork leveling cylinder.

19. The load moving machine according to claim 1 further comprising:
a feedback generator controlled by said computer, said feedback generator comprising at least one of a display system, a visual alarm, an audible alarm, or a tactile feedback mechanism.

20. The load moving machine according to claim 19 wherein:
said display system displays information for informing said operator of a change of said load handling geometry for aiding said operator when the load moving machine is approaching working limits or for informing said operator of changes to said load handling geometry that would increase said load moment beyond a longitudinal pre-determined allowable limit and/or beyond a lateral pre-determined allowable limit.

21. The load moving machine according to claim 19 wherein:
wherein said feedback generator provides outputs that prevent said operator from changing said load handling geometry into configurations that would increase said load moment beyond said longitudinal pre-determined allowable limit and/or beyond said lateral pre-determined allowable limit.

22. The load moving machine according to claim 19 wherein:
said feedback generator is integrated with machine controls and said control system to prevent travel of the load moving machine, to limit or stop travel speed of the load moving machine, or to allow said boom assembly to only move in a direction that will reduce said moment load.

23. A method of detecting machine stability for a load moving machine comprising steps of:
selecting a desired configuration of components to establish a load handling geometry of the load handling machine with a control system;
receiving position data from position sensors operatively located on one or more said components of said load machine;
receiving pressure data from pressure sensors operatively located on one or more pressure cylinders of said load machine;
processing said position data from said position sensors and said pressure data from said pressure sensors with a computer for determining a load moment and for calculating a weight of a load being lifted by utilizing said pressure data and said position data.

24. The method according to claim 23 wherein:
said control system is adapted to manipulate one or more of a boom angle, a boom length, a load radius, and a pivot arm angle.

25. The method according to claim 23 comprising:
generating feedback to an operator by displaying information, displaying a visual alarm, sounding an audible alarm, or alerting the operator with a tactile feedback mechanism.

26. The method according to claim 25 wherein said step of displaying information comprises:
informing said operator of a change of said load handling geometry for aiding said operator when the telehandler is approaching working limits or for informing said operator of changes to said load handling geometry that would increase said load moment beyond a longitudinal pre-determined allowable limit and/or beyond a lateral pre-determined allowable limit.

27. The load moving machine according to claim 25 wherein said step of generating feedback comprises:
providing outputs that prevent said operator from changing said load handling geometry into configurations that would increase said load moment beyond said longitudinal pre-determined allowable limit and/or beyond said lateral pre-determined allowable limit.

28. The load moving machine according to claim 23 wherein said step of generating feedback comprises:
overriding machine controls with said feedback generator to prevent travel of the load carrying machine to limit or stop travel speed of the load moving machine, or to allow said boom assembly to only move in a direction that will reduce a moment load on the load moving machine.
